(19) United States
(12) Patent Application Publication
(10) Pub. No.: US 2010/0104104 A1
(43) Pub. Date: Apr. 29, 2010

(54) Method of Data Item Selection for Trade and Traded Item Controlled Access via Menu/Toolbar driven Interface

(76) Inventor: Shuya Huo, Beijing (CN)

Correspondence Address: The Merek Group, Inc., 1908 Westfield Street, Alexandria, VA, 22308, US

(21) Appl. No.: 12/581,884

(22) Filed: Oct. 20, 2009

Related U.S. Application Data
(63) Continuation-in-part of application No. 10/519,393, filed on Nov. 13, 2006, now Pat. No. 7,607,158.

(51) Int. Cl. G06Q 30/00; G06Q 50/00; G06F 15/173; G06F 15/177; H04L 9/08; G06F 3/048

(52) U.S. Cl. 380/278; 705/26; 709/225; 715/735

(57) ABSTRACT

This invention provides a system that enable a trading network center and participating network operators as well as their selling-subscribers to select for-not-use/for-trade electronic information data items to trade by using an interactive button/menu/toolbar driven interface, such as a browser or onscreen widget; also it enable their buying-subscribers to select and access dealpack by using the same interface through a controlled access process controlled and operated by the trading network center via its trading portal.

This invention is a Continuation-In-Part of U.S. patent application Ser. No. 10/519,393 and is related to the same field as original application the entirety of which is incorporated herein by reference.

### FIELD OF THE INVENTION

### Background of the Invention

The Ser. No. 10/519,393 application presents an eCommerce trading network where it connect participating subscription network operators and allow their subscribers trade their selected for-not-use content items with each other. Although Ser. No. 10/519,393 described the methods of unique selecting, packaging and control delivering processes, it mostly related to a TV guide interface and the embodiment of the implementation only touched the details of a cable TV network based scenario, even it mentioned using internet browser as an interface, it did not further present an embodiment of the implementation.

### SUMMERY OF THE INVENTION

The objective of this invention is to provide a solution that will enable the subscribers of participating network operators to trade their “for-not-use” content data items by using a interface that will be accessible via EPG (Electronic Programming Guide), internet browser and embedded interface to execute the selection process and participating the trading securely in real time. In order to realize the objective, this invention provides a computer implemented button, menu and toolbar driven method for subscriber electronic information data item selection and trade as well as traded items, the dealpack as described by the Ser. No. 10/519,393 application, controlled access by the same and different participating network subscribers.

In one preferred embodiment of the invention, the computer implemented method includes a trading network center controlled interface at client side (text, graphics, sound, touch). The interface embedded/downloads/patches/upgrades a selection software mean, which enable users select desired to view content items by specified time frame and content, and sends out the un-selected for-not-use items to packaging process. This packaging process then will automatically map and group the for-not-use items in accordance with pre-defined grid/matrix, package, label and price them into dealpack. The dealpack then will be listed out for real, delayed, relayed time trading. The system uses a network center controlled trading portal for dealpack indexing, listing, searching, trading, charging and billing as well as for dealpack controlled access by the same or different participating network operators and their subscribers.

The above said computer implemented method for electronic information data item (such as TV program) selection and packaging out for trade comprises an interactive content data item selection mean. Such selection mean functioning as an interface in the form of an button on a screen or a menu or toolbar item of an electronic program guide (EPG) for TV or a web browser or widget of PC, could be interactively operated via a control device, such as a set-top box and/or a hand-held device, that rolling displays the content listing and operates the selection means on a TV/PC screen or via internet web pages directly. The subscriber selects button, or menu/toolbar items via the selection means (such as EPG) manually or passively by automatic prompt. Either way, the system will ask the subscriber to confirm for-trade or performing setups/updates. When confirmed for-trade, which means the setup has been done previously already, the subscriber needs only to confirm for-trade in accordance with the previous setup configuration. When needs to setup or update, the selection process will bring subscriber to do content/time selection for-not-use, wherein the selected menu bar item, could be time frame or time frame group; content item or content items combination (such as program channel/title or channel/title combination), can be triggered to further list out by pre-defined format, such as being listed by categorized content item lists sorted by selected time frames. Time along horizontal axis and items (such as channels/title or channels/titles combination) along vertical axis, Other menu items, such as automatic/manual confirmation for-trade, etc. could be also included in the setup. When selecting items, subscriber can select desired to view items B (time/content) from the entire content lineup list A by check mark/or flag, and with confirmation, the rest items C of list A shall be put as for-not-use in a specified time frame, which are then waiting for subscriber's trade call. Upon receiving the trade call, the for-not-use items along with the subscription data (such as subscriber ID, key and billing data, etc) called from subscription service database, shall be immediately mapped, regrouped, packaged, labeled and priced automatically by the packaging process to generate the dealpacks. The dealpack's physical media data are stored in synchronized and networked database servers located outside the subscription network or within it, waiting for call from buying-subscriber, while dealpack's subscription/label data will be sent into trading database server, which is linked with the network center trading database exchange server, and be populated onto a display format, updated in real time to enable internal (among operator's own subscribers) or external (with subscribers of other network operators) trading via the network trading center's trading portal.

Participating network operator and its subscribers can then search the wanted Dealpacks to purchase. For one preferred embodiment of the invention's internet based video program selection and purchasing, the search result can be a list of prices of the Dealpacks, as well as the purchasing and supply method, etc.. Upon selected the wanted dealpack item to play, when system can be configured to prompt for accepting deduction of the price amount by entering subscriber id and password, or configured via setup for automatic deduction before the start of playing. The trading center then can use debt (settling account with operators by month), or use credit card/bank card as payment tool to close deal online in real time. Once paid, a payment verifier and a random number key factor shall be scrambled with selling-subscriber's secret key and the buying-subscriber shall be given a newly issued Dealpack secret key, which could be administered by the trading network center on behalf of the buying-subscriber to submit for accessing the Dealpack; where the accessing can be a seamless symbolic linking path to the selling-subscriber's home directory via a dummy account or directly; or the new secret key could be submitted by the buying-subscriber him/herself via internet, cable or wirelessly to activate the access of the Dealpack

The Dealpack secret key is generated by a method of assembling and encrypting the selling-subscriber's key (such as account number, password) with Dealpack's ID, network address identifier, time frame identifier (time-tag) and payment verifier together with a random number key factor.

The above mentioned Dealpack secret key authentication access method also comprises: the Dealpack physical data linking, encoding transmission, gateway filtering, buying-subscriber terminal interface decoding and releasing for access. The said controlled access method include steps of: buying-subscriber selects, searches and purchases the secret key for selected Dealpacks; network administrator controls and authenticates the secret key, queries, links the physical Dealpack data, which are stored at synchronized and networked database server, encoded and transmitted at-least-cost-route to the buying-subscriber location.

The unique electronic information data item selection method, coupled with the Dealpack and controlled access key generating processes, results in combined technical effects that enhance the efficiency of utilizing the network resources (statistics shows that about ⅔-¾ of network resources are idle during slow time, such as night time for telecommunication network, early day time and late night time for TV network), the efficiency of processing the electronic information data item (separating the label/subscription data with physical media data, so as to efficiently manipulating and virtual processing the Dealpack data from various sources and synchronizing/transmitting the physical data among distributed and networked database servers directly without going through the trading center) and the unique granulated secure accessing process of the Dealpack that only this invention application uses, allowing seamless business process of two trading network subscribers' selling and buying and fine manipulation of the Dealpack without losing security control.

The objective and characteristics of the invention will become apparent from the following drawings and the detailed description.

### BRIEF DESCRIPTION OF THE DRAWINGS

FIG. 1 is the use case overall diagram of the invention.

FIG. 2 is the electronic information data item selection process flow chart.

FIG. 3 is the packaging process flow chart.

FIG. 4 is the controlled access process flow chart.

FIG. 5 is the block diagram of the gateway filter/censor process.

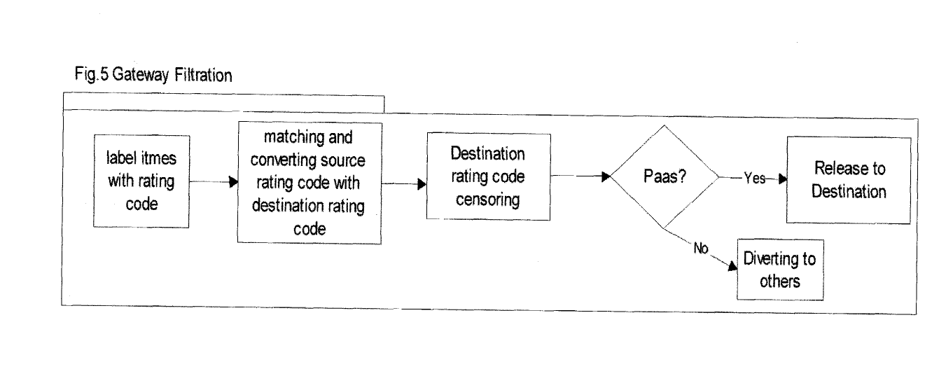

### DETAILED DESCRIPTION

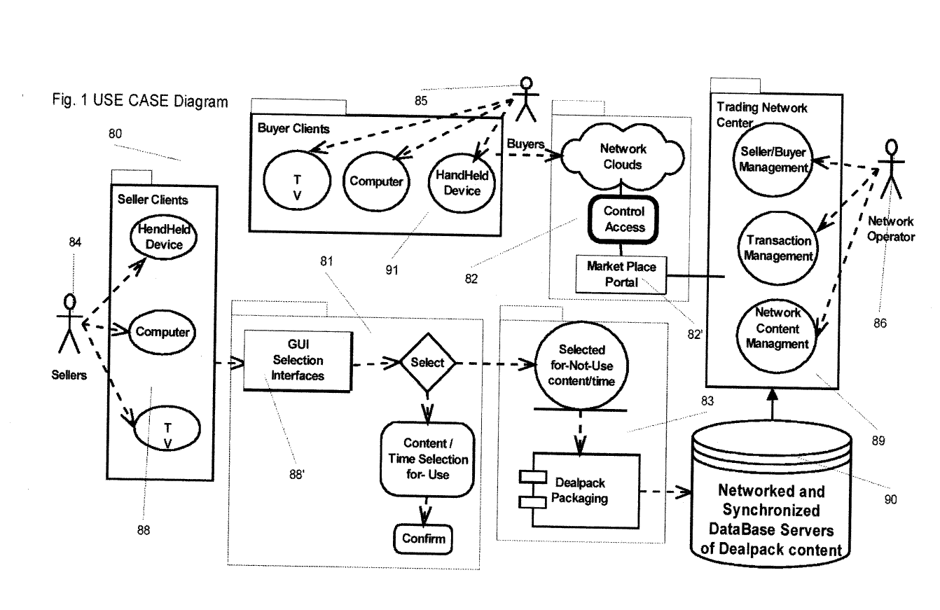

An preferred embodiment of this invention's application situation is to use computer/hand-held interface, such as a browser, to interactively operate in a computer internet network subscription environment. Refer to FIG. 1, the use case diagram gives the general overview of the entire application. Selling-subscriber 84 of a network operator A interactively operates client 88 (in this case, the hand-held device or computer) via GUI (graphical user interface) browser 88′ to use the Electronic Information Data Item Selection process 81, generating the Dealpack contents 90 via packaging process 83, which are to be listed online by trading network center 89 administered by network operator 86; buying-subscriber 85 of other network operator B via its client interface 91 shall be able to access the Dealpack via controlled access process 82 at online market portal 82′.

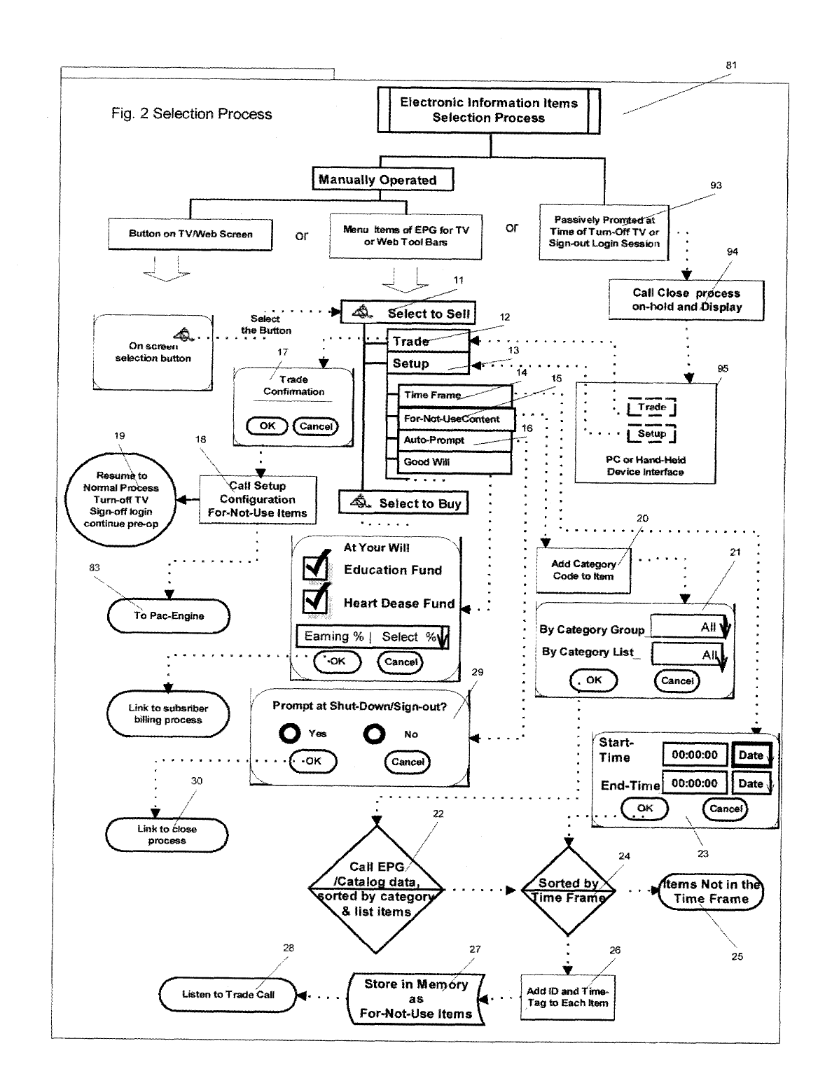

Specifically, refers to FIG. 2, the Electronic Information Data Item Selection Process 81, subscriber operates client 88, and chooses the menu item with selection to sell sign 11 to enter the process, which will pull down the menu with down-line sub-menu items of trade 12, setup 13, etc. When first time selecting so, chooses the menu item setup 13 (it could be arranged to prompting for entering subscriber account number and password here) will pull-down a sub-menu with time frame bar 14, for-not-use content bar 15, auto prompt bar 16, etc.; choosing time frame 14 will open a window to enter start-time and end-time, which define the time frame when subscriber does not use the service, then clicking OK, will start listening to content item selection call to sort the content items; selecting the for-not-use content bar 15, will open a window prompting to select the content items by category and content item list, (if content item does not have category code pre-set, a small process to assign category code is set in front of this step). When selection is done, the click of OK will sort out the selected categories and content items into a selected list 22, and sorted by time frame 24 if the time frame has selected, or listening for time frame 24 call for sorting. The sorted out for-not-use items will be adding ID and time-tag by 26 and stored in memory 27, which is in listening for-trade call status 28. Another setup sub-menu item is auto-prompt 16, it will lead to a window prompt 29 asking whether to be prompted at sign-out 93, selecting yes and OK will link to the close process that will hold-on the close process 94 by prompting on screen a window asking to do Trade 12 or Setup 13. Now the selection of the menu item Trade 12 will lead to a window asking trade confirmation, choosing OK will call the setup pre-configured selected for-not-use items 18, and send it to the next procedure, packaging process, then resume the normal program operation or the sign-out close down process 19.

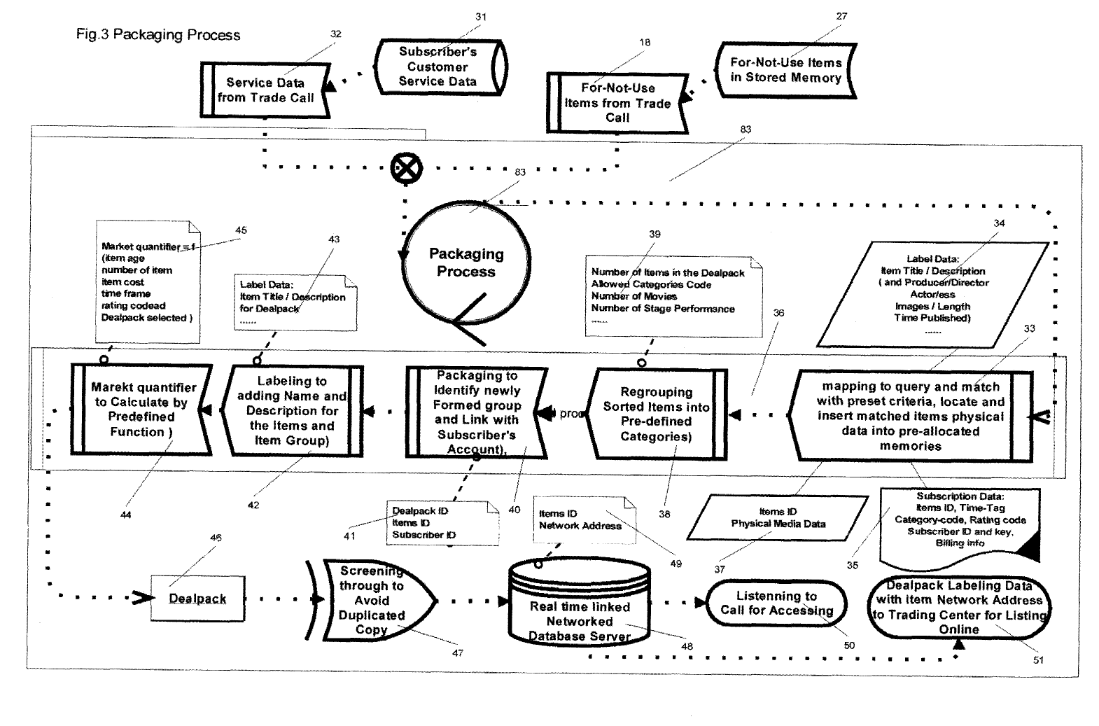

Now refer to FIG. 3 Packaging Process. The for-trade call from above selection process will send the for-not-use items 10 and subscription data 32 to packaging process 83, which will first query the data received by pre-set criteria 33, including matching them with label data 34 and subscription data 35 matrix, then mapping the physical media data item with ID 37 into allocated database server memory 48 with network address assigned 49; the process will then regroup the items 38 by Dealpack specs 39, such as number of items in the Dealpack, allowed category code, number of movies and number of stage performance etc., and package 40 the Dealpack by linking with subscriber account and assign ID 41, label 42 the Dealpack with label data 43 and price 44 the Dealpack by price function 45. This will generate the Dealpack 46, with its physical media data being screened by 47 to avoid duplication and being sent to synchronized network database server 48 to listening call for accessing 50, the label/subscription data of Dealpack shall goes to trading center database server for listing online 51.

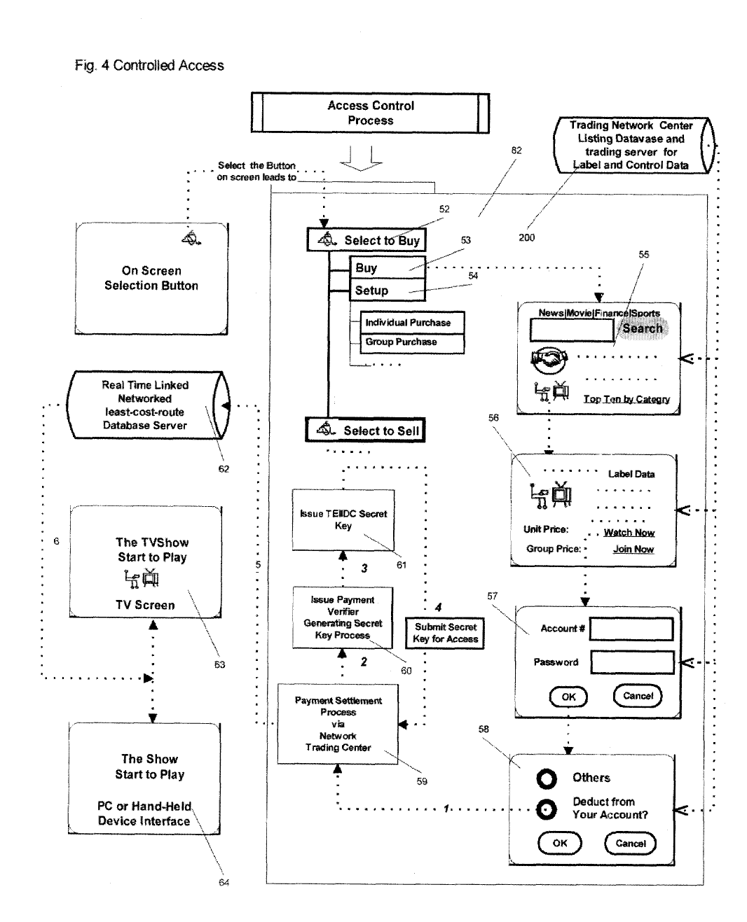

The access control process of subscription network B is illustrated via FIG. 4. The buying-subscriber 85 via his/her terminal interface device 91 browses Dealpacks 51 online. The browser interface 88′ with select sign menu item Select to Buy 52, if selected by subscriber 85, will pull down to show a window 55 which will allow searching by keyword, categories for Dealpacks from listing database at the trading center 200. If a Dealpack is selected, another window 56 will be opened, showing detailed label data and price information by unit and group. When Watch Now is selected, will display a box 57 to enter account number and password of network operator B, with the account number and password verified by database trading server 200 OK, will lead to payment confirmation window 58; with auto deduction selected and OKed, will trigger the trading network center payment settlement process 59; when payment made, will issue a payment verifier and trigger the secret key issuing process 60, that will lead to the issuing of the secret key for the Dealpack; the secret key will be submitted to the trading network center payment settlement process 59 for releasing ticket to synchronized network database server 62 to retrieve the selected Dealpack by Dealpack ID and Item ID, and activate the transmission and display of Dealpack physical media at screen 64.

Note, Dealpacks stored in 48 and 62 servers are synchronized and networked database servers at different regions, transmitting the Dealpack from 48 to 62 is a result of least-cost-routing arrangement, it will require pass the border gateway node for rating code censoring. Only censoring Oked Dealpacks are released to enter 62.

It is to be understood that the above preferred embodiments of the invention only illustrates the key concept and composition of this invention, many variations and modification can be made based on the accent of the above embodiments, which will be apparent to one skilled in the art, that are also within the spirit and scope of the invention as set forth in the claims below.

I claim:

1. A computer implemented method of network subscriber electronic information data item selection for trade and the traded item controlled access by other subscribers from the same and different networks; the method comprises a plurality of sub-methods:
a subscriber electronic information data item selection process, wherein to set-up, select electronic information data items by time and content from a content pool A, put the desired to view data items selected as B items and put the remaining un-selected items as C items, hold the C items in memory as for-not-use, for-trade items listening for-trade call to send out as output;
a packaging process to receiving and processing automatically the for-not-use electronic information data, subscription/network data called from subscription service database, and to generating the Time-tagged Electronic Information Data Items Combination, the Dealpacks, via a process of mapping, regrouping, packaging, labeling and pricing; with the Dealpack label data being sent out for listing online for controlled access in real, delayed or relayed time by buying-subscribers, the Dealpack physical media data are stored with id and unique network address in real time linked with networked database servers, listening for transmission call;
a method for secret key issuance and management.
a method for controlling said Dealpack path and filtering its contents;

2. The network subscriber electronic information data item selection method of claim 1, that is display-able on television or computer operated display interface directly or via internet web browser interface, in the form of a button or a menu driven toolbar item inter-operable for selection setup and configuration, by which once the setup configuration is done, can be used later automatically, repetitively and changeable manually any time in the middle of a session, or passively by system prompt at the end of a session according to the setup configuration; the selection process comprising:
the setup sub-menu bar items of TV's EPG or PC's browser or widget menu of time frame or time frame group, and content item of channel or movie title or content item group; time and content items can be listed out by categorized lists sorted by selected time frame; other menu bar items in the setup configuration sub-menu, could include automatic/manual confirmation for trade; also allowing subscriber to select items by check or flag mark to select content items and time frame or session;
selecting desired to view content items B from the whole content line up A with time frame or session confirmed, and put the rest of content C from list A with same time frame or session as for-not-use items; or
selecting the for-not-use content items C from the content list A with time frame or session confirmed;
holding content list C of for-not-use items with time-tag and selling-subscriber ID, listening for trade call;
confirming trade or selling manually each time in the middle of a session when select so or prompted by system so at the end of a session, or automatically by pre-setup configuration to send out the for-not-use items C as output of the selection process.

3. A method to generate the Dealpack and its label, subscription, network data from the for-not-use electronic information data items list C with time-tag, and from the subscription service database of claim 2 including steps:
receiving output data of for-not-use electronic information data items from above said selection process;
calling subscriber/network data from subscription service database by subscriber ID;
processing the for-not-use electronic information data items and the called data by packaging process through steps of mapping, regrouping, packaging, labeling and pricing to calculate by predefined function for price;
sending the output of packaging process in the form of Dealpack label and subscription/network data into trading database server connected in real time with trading network center for listing;
storing the Dealpack physical media data with items' id and unique network address in real time networked database servers, listening for Dealpack secret key releasing call to transmit.

4. The Dealpack secret key issuance and management method of the trading network from claim 3, comprising:
selecting interested Dealpack by buying-subscriber, where when prompted, entering subscriber account number and password of the participating subscription network to confirm payment;
processing the payment of the buying-subscriber account by trading network center, issuing payment verifier upon payment made;
receiving a payment verifier and a random number key factor by the secret key process, generated by trading network center payment settlement process;
issuing a secret key for Dealpack by an algorithm of assembling and encrypting of the Dealpack selling-subscriber's key including account id, password with the Dealpack's time-tag defining the time frame or session, and ID, network address identifier, payment verifier as well as random number key factor;
submitting the said secret key via internet, cable or wireless network;
administering the issuance and submission of the Dealpack secret key by the trading network center on behalf of the buying-subscribers or by buying-subscriber him/herself;
sending a release ticket to the Dealpack physical media data database server address to activate the transmission upon the said secret key submitted;
accessing Dealpack by buying-subscriber for the specified time frame or session.

5. A subscription network gateway filtration and censoring process of claim 1, comprising the steps:
inserting rating code to the for-not-use electronic information data items;
matching and converting source rating code with destination rating code;
censoring destination rating code;
releasing to destination if censoring passed;
diverting censoring non-passed Dealpack to other destination where censor passed.

6. The physical media data of Dealpack storage of claim 3, can be located outside of selling-subscriber's network or within it.

7. The Dealpack accessing by the buying-subscriber of claim 4, can be seamlessly accessed with one time login by buying-subscriber to a selling-subscriber's dummy account that linked to the selling-subscriber's home directory location adding extra layer of security for the access.

8. A method of network filtration of claim 1, which is used by network gateway interface set on the trade participating networks key border nodes, controlling said Dealpack path and filtering its contents.

9. A method for secret key issuance and management of claim 1, that issuing the secret key to Dealpack buying-subscriber and managing the same and/or different networks subscribers' trading and accessing of the purchased Dealpack.

10. A subscription network e-commerce system, comprising means for performing the computer implemented method of claim 1.

11. The computer program coding instructions, which when executed performs the method steps of claim 1.
